(19) United States
(12) Patent Application Publication
(10) Pub. No.: US 2026/0058532 A1
(43) Pub. Date: Feb. 26, 2026

(54) METHOD FOR PACKAGING SHEET METAL PARTS MADE FROM AN ELECTRICAL STEEL STRIP OR SHEET TO FORM A LAMINATED CORE

(71) Applicant: voestalpine Stahl GmbH, Linz (AT)

(72) Inventor: Ronald Fluch, Linz (AT)

(21) Appl. No.: 19/104,679

(22) PCT Filed: Aug. 18, 2023
(86) PCT No.: PCT/EP2023/072873

§ 371 Date: Feb. 18, 2025

(30) Foreign Application Priority Data
Aug. 19, 2022 (EP) 22191339.5

(51) Int. Cl. H02K 15/0273; H02K 15/027; H02K 15/121

(52) U.S. Cl. CPC H02K 15/0273; H02K 15/027; H02K 15/121; H02K 2213/03

(57) ABSTRACT

A method for packaging sheet metal parts made from an electrical steel strip or sheet to form a laminated core is disclosed. In order to achieve advantageous process conditions, it is proposed that when the hot-melt adhesive varnish layers are pressurized in the axial direction of the stacked sheet metal parts, they are pressurized multiple times by means of a pressure pulse in that the pressure pulse is exerted through either an impingement with pulse pressure or a relief of pulse pressure.

### FIELD OF THE INVENTION

The invention relates to a method for packaging sheet metal parts made from an electrical steel strip or sheet to form a laminated core in which the sheet metal parts, which have a hot-melt adhesive varnish layer, more particularly a backlack, on at least one of their flat sides, are stacked on top of one another, the hot-melt adhesive varnish layers of the stacked sheet metal parts are heated and at a first temperature, which is greater than the glass transition temperature of the hot-melt adhesive varnish of the hot-melt adhesive varnish layers and less than the curing temperature of the hot-melt adhesive varnish of the hot-melt adhesive varnish layers, are pressurized in the axial direction of the stacked sheet metal parts, and then the hot-melt adhesive varnish layers of the sheet metal parts are finally heated to a second temperature, which is greater than or equal to the curing temperature of the hot-melt adhesive varnish, and the sheet metal parts are thus thermally bonded to one another.

### BACKGROUND OF THE INVENTION

In the manufacture of laminated cores out of sheet metal parts coated with a hot-melt adhesive varnish layer, it is known (WO2021175875A1) to exert pressure in the axial direction on the laminated core and thus on the hot-melt adhesive varnish layer during the gluing of the sheet metal parts in order to thus ensure a desired packet height. In addition to an exact packet height, it is also necessary to achieve a full-surface adhesion between the sheet metal parts—this is more particularly the case if the laminated core must be able to withstand pressure in liquid cooling applications—which is more particularly the case with laminated cores in the high-performance realm, for example in electric motors.

### SUMMARY OF THE INVENTION

The object of the invention, therefore, is to modify a method for producing a laminated core of the type explained at the beginning such that a laminated core that is able to withstand liquid cooling can be manufactured with increased reproducibility. In addition, the method should be easy to use and should not require any increased additional effort.

If, while the hot-melt adhesive varnish layers are pressurized in the axial direction of the stacked sheet metal parts, they are pressurized multiple times by means of a pressure pulse, their boundary surface properties can be prepared for the production of a full-surface adhesive bond. This is true even if there are temperature differences in the hot-melt adhesive varnish layer. It is also conceivable that the pressure pulse itself can be used to overcome differences in the flow properties of the hot-melt adhesive varnish layers—which can further facilitate the full-surface adhesive bond between the sheet metal parts through the formation of a more homogeneous boundary layer. For example, the pressure pulse can be exerted through either an impingement of pulse pressure or a relief of pulse pressure.

The method thus makes it possible to reproducibly achieve a liquid-tight bond between the sheet metal parts, which is surprisingly able to withstand even particularly high hydraulic pressures. Also, the pressure changes on the laminated core in the form of pressure pulses do not require any additional, elaborate handling steps, as a result of which the method remains simple to carry out—and in comparison to other methods with a pressurization of the laminated core during bonding, also does not add any increased additional expense.

The use of the method can be further simplified, among other things, if the pressure pulse is respectively exerted through an impingement with pulse pressure and then through an at least partial relief of the pulse pressure, more particularly through relief of essentially the entire pulse pressure. Preferably, a relief of the entire pulse pressure occurs.

The method can be further improved if during the subsequent relief of the pulse pressure, the hot-melt adhesive varnish layers are essentially free of the pressure.

Preferably, this method step of the pulse exertion is kept to a relatively short time in that the duration of the impingement with pulse pressure and/or the subsequent relief of the pulse pressure is in the range from 0.1 to 20 seconds. This is more particularly true if this duration is in the range 0.5 to 5 seconds. It is thus possible, for example, to minimize the risk of hot-melt adhesive varnish being squeezed out from the bonding gap between the sheet metal parts. Preferably, the duration for the impingement with pulse pressure is equal to the duration for the subsequent relief of pressure.

For example, the pressure pulse acts on the hot-melt adhesive varnish layers with somewhere in the range from 0.5 to 10 N/mm² (Newtons per square millimeter). Preferably, the pressure pulse acts on the hot-melt adhesive varnish layers with pulse pressure in the range from 2 to 6 N/mm² in order to thus also minimize the risk of hot-melt adhesive varnish being squeezed out from the bonding gap between the sheet metal parts.

Simple process conditions can be achieved if the first temperature is in the range from 80 to 220° C. Preferably, the first temperature is in the range from 80 to less than 180° C. If the first temperature is in the range from 100 to 150° C., then it is possible, for example, to minimize the risk of hot-melt adhesive varnish being squeezed out from the bonding gap between the sheet metal parts.

If the multiple pressurizations by means of the pressure pulse occur in immediate succession, then this can further improve the homogenization of the boundary surface properties. This is even more the case if the multiple pressurizations by means of the pressure pulse occur periodically.

It can also turn out to be advantageous if the hot-melt adhesive varnish layers are pressurized multiple times by means of the pressure pulse in a first time interval of a pressure curve and are pressurized by means of a constant pressure in at least one other time interval of the pressure curve. Preferably, the other time interval is two to four times longer than the first time interval.

Preferably, the length of the other time interval is in the range from 0.5 to 180 seconds, more particularly from 60 to 120 seconds.

For example, the length of another second time interval can be in the range from 0.5 to 120 seconds, more particularly 60 seconds.

For example, the length of another third time interval can be in the range from 30 to 180 seconds, more particularly 120 seconds. Preferably, the second time interval chronologically precedes the third time interval. For example, the first time interval can be between the other second time interval and the other third time interval.

It is conceivable that the hot-melt adhesive varnish layers are pressurized multiple times by means of the pressure pulse in such a way that a full-surface adhesive bond is produced without adhesive being squeezed out from the bonding joints between the sheet metal parts.

Simple process conditions can be achieved if the second temperature is in the range from 180° C. to 250° C., more particularly from 180° C. to 220° C.

Preferably, sheet metal parts that have the hot-melt adhesive varnish layer, more particularly backlack, on both of their flat sides are stacked on top of one another. It is thus possible to further increase the ability of the laminated core to withstand liquid cooling since the bonding is reduced to a connecting surface between two similar joining partners. In addition, the pressure pulse can influence both of the viscous hot-melt adhesive varnish layers at the same time, which can further improve the bond between them and thus between the sheet metal parts.

Preferably, the thickness of each sheet metal part is between 0.09 and 0.49 mm, more particularly 0.09 to 0.29 mm, and/or the thickness of the hot-melt adhesive varnish layer of each sheet metal part is between 2 and 12 μm, more particularly from 4 to 8 μm. It is thus possible to achieve particularly advantageous preconditions for a high reproducibility of the method.

In the method, it is conceivable, for example, that the pressurization is carried out on a preferably pre-bonded laminated core. This is achieved in that the sheet metal parts are stacked in a stacking unit, after exiting the stacking unit in the form of a laminated core, more particularly a pre-bonded one, whose hot-melt adhesive varnish layers are pressurized multiple times by means of the pressure pulse in a pressurizing unit and then undergo final heating.

Alternatively, it is conceivable that while avoiding the use of a pre-bonded laminated core, the following method steps are carried out in a pressurizing unit: stacking of individual sheet metal parts to form a laminated core, heating of their hot-melt adhesive varnish layers, multiple pressurizations by means of the pressure pulse, and then final heating as needed.

Preferably, the packet height of the laminated core is determined multiple times with the aid of a measuring method, specifically in at least one time interval of the time intervals occurring between two chronologically successive pressure pulses. There are thus available data that can be used to regulate the process. This can be done, for example, in that a difference value is calculated from two packet heights determined in chronological succession and when a calculated difference value falls below a predetermined minimum, more particularly for the first time, the pressurization of the laminated core by means of the pressure pulses is terminated. The method can thus be more reliable. For example, a predetermined minimum can approach zero or can, for example, be an absolute minimum that is arrived at based on the calculated difference values.

For example, with the aid of the measuring method, the packet height (hp) is also determined chronologically before the first pressure pulse of the pressure pulses in order to thus be able to produce a maximum value as the first difference value (Δhp). It is thus possible to better predict, for example, the behavior of the laminated core in subsequent pressure pulses.

Preferably, the predetermined minimum is 10%, 5%, or 2% of the first calculated difference value (Δhp). For example, 10% can be advantageous in a sequence of comparatively small difference values (Δhp), whereas 5% or 2% can be more advantageous in a sequence of comparatively large difference values (Δhp).

### BRIEF DESCRIPTION OF DRAWINGS

The subject of the invention will be presented in greater detail below based on embodiment variants shown in the figures. In the drawings:

FIG. 1 shows a schematic depiction of an apparatus for carrying out the method according to the invention,

FIG. 2 shows a pressure curve with which a pre-bonded laminated core from FIG. 1 is pressurized in its axial direction,

FIG. 3a shows a cross-sectional view of a bonding gap between two sheet metal parts of the laminated core according to FIG. 2 that has not yet been pressurized with the pulse pressure,

FIG. 3b shows a cross-sectional view of a bonding gap between two sheet metal parts after the hot-melt adhesive varnish layers have been pressurized with the pulse pressure according to FIG. 2, and

FIG. 4 shows an alternative apparatus for carrying out the method according to the invention.

### DETAILED DESCRIPTION OF THE INVENTION

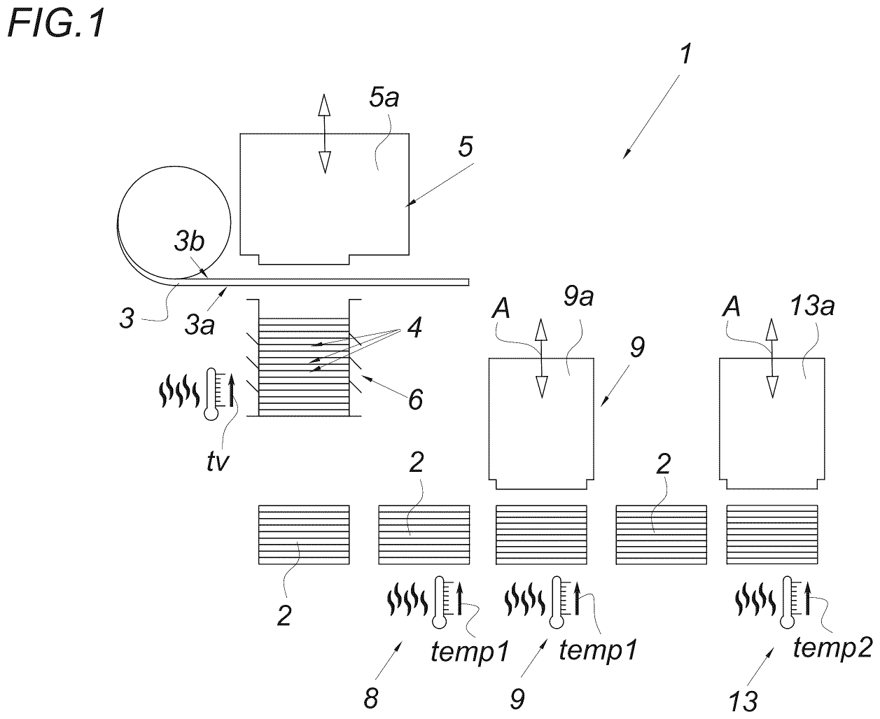

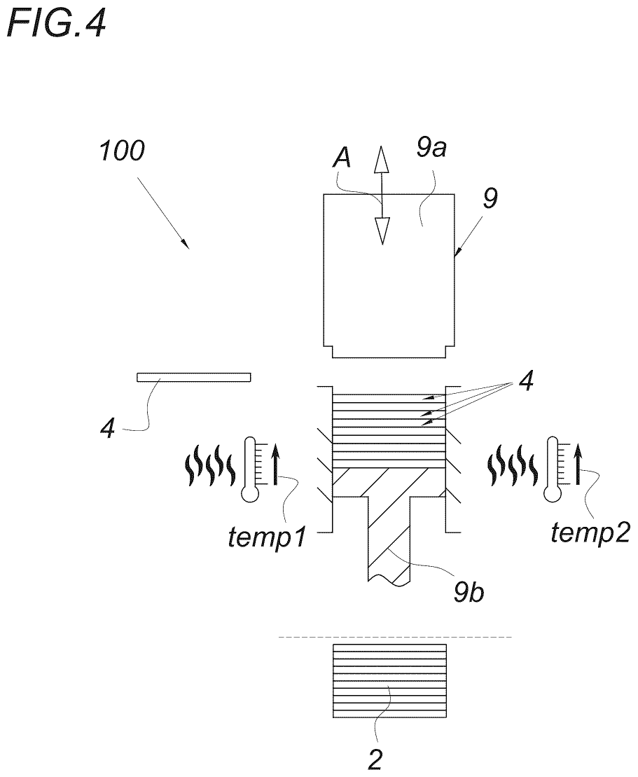

FIGS. 1 and 4 show apparatuses 1, 100 that are used to produce a laminated core 2, which is preferably used for electromagnetic components, for example for electric machines.

To accomplish this, a first apparatus 1—see FIG. 1—cuts multiple sheet metal parts 4 from an electrical steel strip 3. The electrical steel strip 3 is coated on both of its flat sides 3a, 3b with a thermosetting hot-melt adhesive varnish layer 7, for example one that is epoxy resin-based and that uses dicyandiamide as a cross-linking agent. The thermosetting or heat-curing hot-melt adhesive varnish layers 7 can consist of backlack. For example, a catalyzed backlack can also be used, such as a backlack with a depot coating to achieve a faster complete reaction.

The hot-melt adhesive varnish 7a or the hot-melt adhesive varnish layer 7 is in the B sate, with the glass transition temperature Tg of the hot-melt adhesive varnish 7a that is used for example being in the range from 65 to 85° C. (degrees Celsius), measured in accordance with ISO 11357-2. The curing temperature of the hot-melt adhesive varnish 7a that is used for example is in the range of greater than or equal to 180 degrees Celsius. These characteristic values of the glass transition temperature and curing temperature can, however, vary in accordance with the hot-melt adhesive varnish 7a that is used.

The sheet metal parts 4 are cut out by a punching die 5, which can also be part of a progressive stamping tool that is not shown. Other devices for cutting out sheet metal parts 4, for example with lasers, are also conceivable. Preferably, the thickness of each sheet metal part 4 is between 0.09 and 0.49 mm (millimeter), namely 0.24 mm, and the thickness of the hot-melt adhesive varnish layer 7 is between 2 and 12 μm (micrometer), namely 5 μm. This also applies to the electrical steel strip 3 from which the sheet metal part 4 is cut. This results in a thickness for each individual lamination in the laminated core 2 in the range between 0.1 and 0.5 mm.

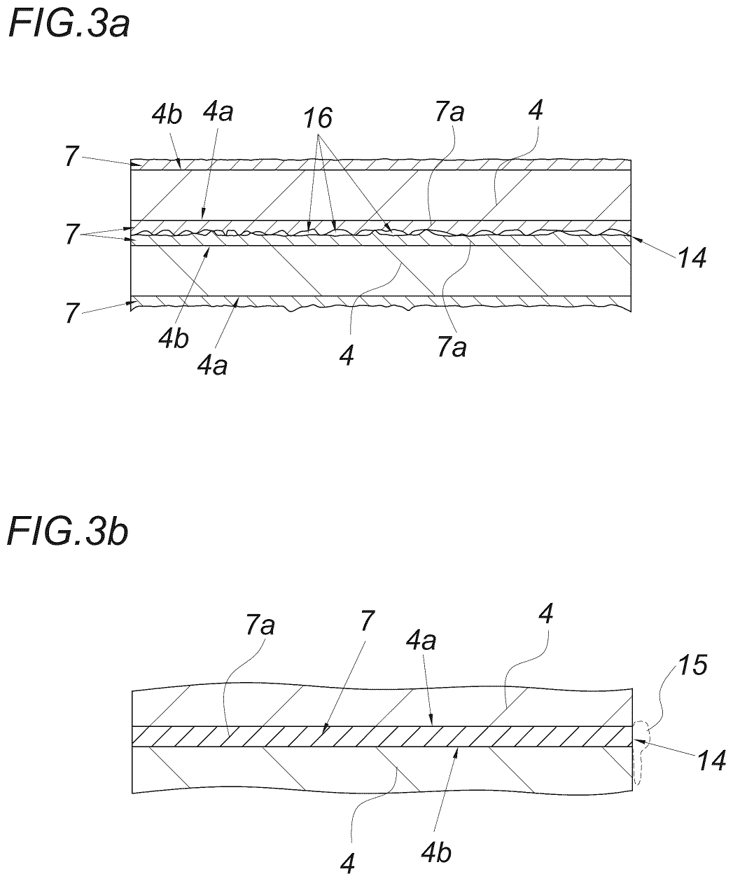

The punch 5a of the punching die 5 pushes the sheet metal parts 4 into a stacking unit 6. The sheet metal parts 4, which have a hot-melt adhesive varnish layer 7, namely a backlack, on at least one of their flat sides 4a, are stacked on top of one another in this stacking unit 6. In the exemplary embodiment—as can also be seen in FIG. 3a, the sheet metal parts 4 have this hot-melt adhesive varnish layer 7 on both of their flat sides 4a, 4b.

In the stacking unit 6, the hot-melt adhesive varnish layers 7 are brought to a temperature tv, which is above a glass transition temperature Tg of its hot-melt adhesive varnish 7a, namely to a temperature tv of 100° C. (100 degrees Celsius). In addition, the hot-melt adhesive varnish layers 7 are pressurized at 3 N/mm² (Newton per square millimeter) for 30 seconds. The sheet metal parts 4 are thus pre-bonded into a laminated core 2.

All of the stacked sheet metal parts 4 exit the stacking unit 6 in the form of pre-bonded laminated cores 2 and are separated into pre-bonded laminated cores 2 at the moment or after they exit the stacking unit 6—which is not shown.

These pre-bonded laminated cores 2 then undergo additional method steps-specifically, the laminated core 2 is introduced into a first furnace 8 in order to bring the hot-melt adhesive varnish layers 7 of the stacked sheet metal parts 4 to a first temperature temp1, which is above a glass transition temperature Tg of its hot-melt adhesive varnish 7a and below the curing temperature of its hot-melt adhesive varnish 7a.

It is, however, conceivable—though this is not shown in detail—for the sheet metal parts 2 to be brought to this first temperature temp1 in the stacking unit 6, before they have even exited it—which makes the method step with the first furnace 8 unnecessary.

In another step, after the laminated core 2 has exited the stacking unit 6, it is introduced into a pressurizing unit 9, which pressurizing unit 9 uses a press plunger 9a to exert an axial compressive force P on this laminated core 2—i.e. in the axial direction A of the laminated core 2, which direction A is parallel to the stacking direction of the stacked sheet metal parts 4. Two of these stacked sheet metal parts 4 are shown in FIG. 3a.

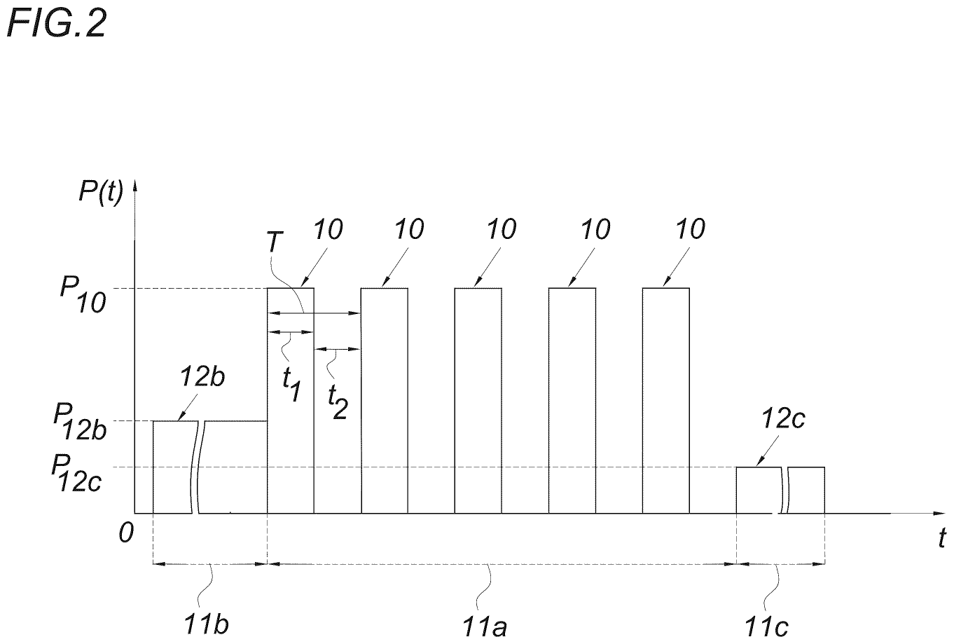

This takes place in a particular way—see pressure P or compressive force P(t) in FIG. 1 in connection with FIG. 2. FIG. 2 shows that the pre-bonded laminated core 2 is individually pressurized in its axial direction A multiple times, five times in the exemplary embodiment, by means of a pressure pulse 10 in that an impingement with pulse pressure P₁₀ and a subsequent relief of pressure P are carried out. This produces a periodic pulse sequence.

According to exemplary embodiment 2, the relief corresponds to the exerted pulse pressure P₁₀; it is conceivable for a remainder of the pulse pressure P₁₀ to remain.

As seen in the pressure curve P(t) according to FIG. 2, the hot-melt adhesive varnish layers 7 are essentially free of pressure P due to the subsequent relief.

The pressure pulse 10 shown essentially follows a rectangular curve, as ideally depicted, for example, in FIG. 2. Preferably, the pressure pulse 10 has a unipolar pulse form.

This pulse pressure P₁₀ reliably compensates for irregularities. This is true even if temperature differences in the respective sheet metal part 4 cause there to be an inhomogeneous flow property of the hot-melt adhesive varnish over the entire bonding surface. According to the invention, these inhomogeneities can be overcome with the pressure pulse 10, thus enabling particularly reproducible manufacture of laminated cores 2 that are able to withstand liquid cooling. This pulse pressure P₁₀ is quite particularly effective in the bonding of the hot-melt adhesive varnish 7a of the hot-melt adhesive varnish layer 7 on one flat side 4a of the sheet metal part 4 to a hot-melt adhesive varnish 7a of the hot-melt adhesive varnish layer 7 on the flat side 4b of an adjacent sheet metal part 4, as shown in FIGS. 3a and 3b.

But this can also improve a bonding of the hot-melt adhesive varnish 7a of the hot-melt adhesive varnish layer 7 to a blank sheet metal part 4, which is not shown in detail here.

As also shown in FIG. 2, in the exemplary embodiment, the pre-bonded laminated core is subjected to uniformly high pulse pressure P₁₀ in its axial direction A five times in immediate succession in a first time interval 11a of a pressure curve P(t), which occurs periodically with the period duration of T, by means of the pressure pulse 10, which has a unipolar pulse form. Preferably when the pulse pressure P₁₀ is relieved, the laminated core 2 is unpressurized—it is also conceivable, however, for the pressure pulse 10 to be overlaid with a constant compressive force so that even when the pulse pressure P₁₀ is relieved, a pressure P still acts on the hot-melt adhesive varnish layers 7, which is not show in detail here.

To produce the pressure pulse 10, the press 9 acts on the laminated core 2 with a pressure P in the amount of P₁₀ or with the pulse pressure P₁₀ in the range from 0.5 to 20 N/mm², namely 5 N/mm². This impingement of pressure P and relief of this pressure P is carried out with the same duration t₁ and t₂, respectively, which results in a period T in the range from 0.1 to 20 sec, namely 2 seconds.

In this method step, the hot-melt adhesive varnish has a first temperature temp1 in the range from 80 to 220° C., namely 120° C.

Due to control or regulation-related minimum requirements, after the relief of the pulse pressure P₁₀, a comparatively minimal pressure P in the amount of 0.1 N/mm² can continue to act, which has not been shown in detail here, which can, for example, constitute the relief of essentially the entire pulse pressure P₁₀.

The pulse pressure P₁₀ can be sufficient to achieve a complete bonding of the two hot-melt adhesive varnish layers 7 to each other in order to thus eliminate the open areas 16 between the hot-melt adhesive varnish layers 7, as are shown in FIG. 3a. This can also significantly improve the bonding of the sheet metal parts 4 to one another, which in turn further increases the durability of the laminated cores 2 manufactured by means of the method according to the invention.

In an optional second time interval 11b of the pressure curve P(t), the laminated core 2 is pressurized with a constant pressure 12b, specifically in the amount of P_{12b} in the range from 2 to 10 N/mm², namely 2 N/mm² for 60 seconds. The second time interval 11b occurs chronologically before the first time interval 11a.

In an optional third time interval 11c of the pressure curve P(t), the laminated core 2 is pressurized P with a constant pressure 12c, specifically in the amount of P_{12c} in the range from 0.5 to 10 N/mm², namely 1 N/mm², for 120 seconds. The third time interval 11c occurs chronologically after the first time interval 11a.

In addition—as shown in FIG. 1—the laminated core 2 or more precisely its hot-melt adhesive varnish layer 7 is kept at the first temperature temp1 during the pressing. In addition, the three time intervals 11b, 11a, 11c mentioned are performed by the pressurizing unit 9.

The sheet metal parts 4 are then cured to form a laminated core 2 or more precisely, the hot-melt adhesive varnish 7a is converted into the C state for this purpose. To achieve this, the laminated core 2 is introduced into a second furnace 13 and in it, the hot-melt adhesive varnish layers 7 of the laminated core 2 undergo final heating to a second temp2, which is greater than or equal to the curing temperature of the hot-melt adhesive varnish 7a of the hot-melt adhesive varnish layers 7, in order to thermally bond the sheet metal parts 4 to one another with a sufficiently long curing time and with the exertion of a constant pressure in the axial direction A of the stacked sheet metal parts by means of a furnace plunger 13a. For example, the second temperature temp2 is 200° C. (200 degrees Celsius) and the bonding time is 1 minute with a pressure impingement of 0.3 N/mm² on the laminated core.

The method according to the invention is therefore extremely flexible and manufactures pressure-resistant laminated cores 2 with a high degree of reproducibility—while not squeezing out adhesive from a respective bonding joint 14 between the sheet metal parts 4. As a result, there is no need to reckon with the formation of a drop 15—shown with a dashed line in FIG. 3b—outside of the bonding joint 14.

Such a squeezing-out of adhesive is to be expected, for example, if the laminated core 2 is cured according to the prior art immediately after the stacking of the sheet metal parts 4 at a temperature of 200 degrees Celsius, with a curing time of 1 minute and with a pressure exertion of 3 N/mm² in order to thus also ensure an ability to withstand pressure.

A risk of adhesive being squeezed out from a respective adhesive gap 14 between the sheet metal parts 4 is further reduced by regulating the number of pressure pulses.

This can be achieved by determining the packet height hp of the laminated core 2 multiple times with the aid of a measuring method, specifically chronologically before the first pressure pulse 10 and in each time interval of the time intervals between two chronologically successive pressure pulses 10. A difference value Δhp is calculated from each pair of packet heights hp determined in chronological succession.

It is thus possible to estimate the effect of the pressure pulses 10. This is done in that when a calculated difference value Δhp falls below a predetermined minimum for the first time, the pressurization P of the laminated core 2 by means of the pressure pulses 10 is terminated. The method thus promptly stops before adhesive is squeezed out from a respective bonding joint 14.

Depending on the requirements, this predetermined minimum can be set to 10%, 5%, or 2% of the first calculated difference value Δhp. Since the packet height hp is determined before the first pressure pulse 10, the first calculated difference value Δhp is also the first value in the sequence of difference values Δhp, which significantly improves the regulation.

An alternative apparatus 100 is shown in FIG. 4. In this case, all of the method steps for manufacturing a laminated core 2 out of sheet metal parts 4 take place in a pressurizing unit 9.

First, individual sheet metal parts 4 are stacked to form a laminated core 2. The sheet metal parts can, for example, be supplied by a punching device that is not show in greater detail here.

Then the hot-melt adhesive varnish layers 7 are heated to the first temperature temp1 and pressurized P, specifically with a press plunger 9a and a counter support 9b. The exertion of pressure (P) multiple times by means of a pressure pulse (10) takes place as described in connection with FIG. 2.

Then the hot-melt adhesive varnish layers 7 are cured and thus converted into the C state by heating the hot-melt adhesive varnish layers 7 to a temperature temp2. Here, too, the parameters are set in the same way as the ones described in connection with the second furnace 13 in FIG. 1.

It should be noted in general that the German expression “insbesondere” can be translated as “more particularly” in English. A feature that is preceded by “more particularly” is to be considered an optional feature, which can be omitted and does not thereby constitute a limitation, for example, of the claims. The same is true for the German expression “vorzugsweise”, which is translated as “preferably” in English.

1. A method for packaging sheet metal parts made from an electrical steel strip or sheet to form a laminated core, comprising:
stacking a plurality of the sheet metal parts on top of one another, wherein each of the plurality of sheet metal parts has a hot-melt adhesive varnish layer on at least one flat side,
heating the hot-melt adhesive varnish layers of the stacked sheet metal parts and at a first temperature, which is greater than a glass transition temperature of a hot-melt adhesive varnish used to form the hot-melt adhesive varnish layers and less than a curing temperature of the hot-melt adhesive varnish used to form the hot-melt adhesive varnish layers, pressurizing the hot-melt adhesive varnish layers in an axial direction of the stacked sheet metal parts a plurality of times using a pressure pulse exerted through either an impingement with pulse pressure or a relief of pulse pressure,
and then finally heating the hot-melt adhesive varnish layers of the sheet metal parts to a second temperature, which is greater than or equal to the curing temperature of the hot-melt adhesive varnish, and thus thermally bonding the plurality of sheet metal parts to one another.

2. The method according to claim 1, wherein the pressure pulse is respectively exerted through an impingement with pulse pressure and then through an at least partial relief of the pulse pressure.

3. The method according to claim 2, wherein during the subsequent relief of the pulse pressure, the hot-melt adhesive varnish layers are essentially free of pressure.

4. The method according to claim 2, wherein a duration of the impingement with pulse pressure and/or the subsequent relief of the pulse pressure is in a range from 0.1 to 20 seconds.

5. The method according to claim 1, wherein the pressure pulse acts on the hot-melt adhesive varnish layers with pulse pressure in a range from 0.5 to 10 N/mm².

6. The method according to claim 1, wherein the first temperature is in a range from 80 to 220° C.

7. The method according to claim 1, wherein the plurality of impingements of pressure using the pressure pulse occur in immediate succession and/or periodically.

8. The method according to claim 1, wherein the hot-melt adhesive varnish layers are pressurized the plurality of times using the pressure pulse in a first time interval of a pressure curve P(t) and are pressurized using a constant pressure in at least one other time interval of the pressure curve P(t).

9. The method according to claim 8, wherein a length of the at least one other time interval is in a range from 0.5 to 180 seconds.

10. The method according claim 1, wherein the hot-melt adhesive varnish layers are pressurized the plurality of times using the pressure pulse in such a way that a full-surface adhesive bond is produced without squeezing out adhesive from the bonding joints between the plurality of sheet metal parts.

11. The method according to claim 1, wherein the second temperature is in a range from 180° C. to 250° C.

12. The method according to claim 1, the plurality of sheet metal parts that have the hot-melt adhesive varnish layer on both of their flat sides are stacked on top of one another.

13. The method according to claim 1, wherein a thickness of each sheet metal part is between 0.09 and 0.49 mm, and/or a thickness of the hot-melt adhesive varnish layer of each sheet metal part is between 2 and 12 μm.

14. The method according to claim 1, further comprising stacking the plurality of sheet metal parts in a stacking unit,
and after the plurality of sheet metal parts exit the stacking unit as a laminated core whose hot-melt adhesive varnish layers are pressurized the plurality of times using the pressure pulse in a pressurizing unit, the laminated core undergoes final heating.

15. The method according to claim 1, wherein the following steps are carried out in a pressurizing unit:
stacking the plurality of individual sheet metal parts to form a laminated core,
heating the hot-melt adhesive varnish layers of the stacked sheet metal parts,
pressurizing the hot-melt adhesive varnish layers a plurality of times using the pressure pulse, and
applying final heating to the laminated core as needed.

16. The method according to claim 1, further comprising using a measuring method to determine a packet height of the laminated core multiple times, specifically in at least one time interval of the time intervals occurring between two chronologically successive pressure pulses, a difference value is calculated from two packet heights determined in chronological succession, and if a calculated difference value falls below a predetermined minimum, a pressurization of the laminated core using the pressure pulses is terminated.

17. The method according to claim 16, wherein with the aid of the measuring method, the packet height is also determined chronologically before a first pressure pulse of the pressure pulses.

18. The method according to claim 16, wherein the predetermined minimum is 10%, 5%, or 2% of the first calculated difference value.

19. The method according to claim 1, wherein the pressure pulse is respectively exerted through an impingement with pulse pressure and then through relief of essentially the entire pulse pressure.

20. The method according to claim 1, wherein the pressure pulse acts on the hot-melt adhesive varnish layers with pulse pressure in a range from 2 to 6 N/mm².
